(19) United States
(12) Patent Application Publication
(10) Pub. No.: US 2017/0240355 A1
(43) Pub. Date: Aug. 24, 2017

(54) LIFTER-COMPATIBLE TELESCOPING BIN

(71) Applicant: Big Belly Solar, Inc., Newton, MA (US)

(72) Inventors: Jeffrey SATWICZ, Waltham, MA (US); David J. SKOCYPEC, Medfield, MA (US); Kevin MENICE, Stoughton, MA (US); Thomas OLSEN, Boston, MA (US); Brian PHILLIPS, Sherborn, MA (US)

(21) Appl. No.: 15/428,840

(22) Filed: Feb. 9, 2017

Related U.S. Application Data
(60) Provisional application No. 62/266,349, filed on Dec. 11, 2015.

(51) Int. Cl. B65F 1/14; B65F 1/12; B65F 1/02

(52) U.S. Cl. CPC B65F 1/1405; B65F 1/02; B65F 1/1473; B65F 1/122; B65F 2220/1066; B65F 2250/114

(57) ABSTRACT

Disclosed herein is a bin that has a first portion configured to hold at least one item therein and an adjustable second portion. The adjustable second portion is configured to couple with the first portion and slide relative to the first portion between a collapsed position and an expanded position. The collapsed position provides a minimum combined height for the first portion and the adjustable second portion in which the adjustable second portion encapsulates the first portion in order for the bin to be placed inside a receptacle. The expanded position provides a maximum combined height for the first portion and the adjustable second portion in order for the bin to interface with a mechanical device for disposing of the at least one item. The bin also includes one or more holding mechanisms for securing the bin in at least one of the collapsed and expanded positions.

### PRIORITY INFORMATION

The present application is a non-provisional application of U.S. Provisional Application No. 62/266,349, filed Dec. 11, 2015, the contents of which are incorporated herein by reference in its entirety.

### BACKGROUND

1. Technical Field

The present disclosure relates to trash receptacles and more specifically to lifter-compatible telescoping bins for trash receptacles.

2. Introduction

Waste bins are typically emptied using manual labor. The waste collector typically lifts the bin or bag from ground level into the back of a waste truck. Due to regulations in lifting weight restrictions, more waste collectors are adopting mechanical devices on the truck that perform the lifting task. The bins that interface with these mechanical devices have tightly controlled interface requirements and typically have wheels to allow the waste collector to wheel the bin to the truck.

Due to closely-specified height requirements on the interface geometry, using a standard lift bin inside a public space compactor is not feasible. The waste disposal interface on the compactor is generally at the same height as the waste truck interface. Raising the height of the waste truck interface would also raise the height of the waste disposal interface above ergonomic standards. The additional height of the bin would cause the compactor to be much taller as well, which would create a visually displeasing design for city streets. Accordingly, current bin solutions do not adequately conform to the space requirements of a public space compactor as well as the height requirements of the waste truck interface.

### SUMMARY

Additional features and advantages of the disclosure will be set forth in the description which follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to provide a new bin geometry that would allow a bin to fit into a public space waste compactor and transform its geometry outside the compactor as necessary to properly interface with a waste collection vehicle. The bin can thus adapt according to the interface requirements of the waste collection vehicle, while still conforming to the specific space requirements of the public space compactor. Waste collectors can easily adjust the bin to couple to a mechanical device which performs the lifting task when emptying the bin.

Disclosed are lifter-compatible bins. A bin can be designed as a two-piece, collapsible, telescoping bin that can fit in the compactor in a collapsed mode and interface with the waste vehicle in an extended mode. Inside the compactor, the bin can be collapsed so the bin can fit the internal geometry of the compactor. Outside the compactor, the bin can be extended to interface with the waste truck at a predetermined height or range of heights. When outside the compactor, the bin can be extended and wheeled to the waste truck, and coupled to the interface of the waste truck or mechanical device for performing the lifting task.

The bin can be fixed in place to hold the waste. The bin can also have features for wheels. The wheels can allow the bin to be wheeled for easy movement. Moreover, the bin can include two portions: a lower bin and an upper sleeve. The sleeve can slide up and down on the bin. The sleeve and/or lower bin can have features for interfacing with a waste truck. The sleeve can be flexed to assemble on the bin. Once installed, the motion of the sleeve can be constrained to prevent the sleeve from falling off or being pulled high enough to be separated from the lower bin.

The sleeve can also include handles for the waste collector to grab and move the bin. A bin handle can have design attributes that improve grip ergonomics, sleeve rigidity, and center-of-mass balancing for improved user experience. The mass of the weighted handle can counterbalance the weight of the trash load when the bin is tipped forward at angles commonly seen when the bin is wheeled by an individual.

The bin can have a collapsed position and an extended position. In the collapsed position, the sleeve (moving top portion) and lower bin (fixed lower portion) can form the same upper profile so the unit becomes one bin. The sleeve can be prevented from sliding off the bottom of the bin by features (such as a flange or extension) in the bottom of the bin to constrain the sleeve's motion. These features can have a return lip to limit the likelihood of the bin flexing and sliding past the stop. In the collapsed position, the height of the bin can be around 22 inches, for example.

In the extended position, the sleeve can rise up on the lower bin. A continuous lip around the bottom of the sleeve can prevent the sleeve from moving past the top of the lower bin. This lip can also be used to lift the weight of the bin and the waste inside when interfacing with the truck. When the sleeve rises up on the lower bin to the extended position, the waste truck interface features can also extend to the correct height.

The extended position can also provide an ergonomic handle height for the collector to wheel the bin from the compactor to the waste truck. The grip of the handle can be around 1.25 inches in diameter, for example. This grip size can provide for ergonomic handling of the bin. The handle can be made out of various materials, such as steel or aluminum. Steel can add weight (e.g., 4 pounds of weight) to the top of the bin. When the bin is wheeled around, this weight can act as a counterbalance to the compacted waste in the bin, making the bin easier to maneuver.

The height of the bin at the extended position can be around 35 inches in some configurations. The sleeve can be prevented from falling down by features (such as a lip, a flange or an extension) in the side wall of the bin. This can be done without moving parts. The material (e.g., plastic) of the lower bin and sleeve can flex as the sleeve is extended up. Once in the up position, the sleeve and lower bin can return to their normal dimensions, and the sleeve can be held in place. A latch feature can be built into the molded sleeve to engage with a lip on the bin that holds the sleeve in the up position.

To return to a collapsed position, the user can pull out the latch and press on the top of the sleeve, causing the sleeve and bin to flex and let the sleeve pass by. The molded features can include bumps that prevent the sleeve from catching on the bin as it slides down. Alternately, this could be done by a moving pin or clasp that is unlatched prior to collapsing the bin.

The bin can include various truck interface features. For example, with the sleeve extended, the two-piece design can function similar to a standard fixed lift bin. The user can wheel the bin over to the lift device, and the device can lift the bin to empty the waste.

There are industry standards for lift bin design that allow interface with various styles of truck-mounted lifters. Some example lifters can utilize ‘comb’ or ‘bar’ style interfaces. The comb style lifter can engage a molded (overhang) design feature in the bin. The bar style lifter can engage a (metal) bar attached to the bin. The lift bin can conform with industry standards for lifter compatibility.

The bin can also include ejection features. One problem facing current lift bins is extracting the waste from the bin. In many cases, the waste can be wedged in tightly and does not easily fall out. The bin described herein can address or correct this problem. For example, with the two-piece design described herein, the design of the bin can allow the bin to slide forward with the bin in the dumped position. Upon sliding forward and hitting a sudden stop at the bottom of its motion, the stop can create a shock to the waste, ejecting materials into the waste truck.

In one aspect, the disclosure describes a telescoping bin including a lower bin for holding deposited items and an adjustable upper bin coupled with the lower bin. The adjustable upper bin is configured to slide down below a first portion of the lower bin to a collapsed position and slide up above a second portion of the lower bin to an extended position. A height of the extended position conforms to a height requirement associated with mechanical processing to remove deposited items in the lower bin via an interfacing component of the adjustable upper bin.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only exemplary concepts of the disclosure and are not therefore to be considered to be limiting of its scope, the principles herein are described and explained with additional specificity and detail through the use of the accompanying drawings in which:

FIG. 1 illustrates an example bin;

FIG. 2A illustrates an example bin in a collapsed position;

FIG. 2B illustrates an example bin in an extended position;

FIG. 3 illustrates an example weighted handle on a bin;

FIG. 4A illustrates an example view of a bottom catch system for a sleeve in a collapsed position;

FIG. 4B illustrates an example return lip on a bottom catch system;

FIGS. 4C-D illustrate example views of a top catch system for a sleeve in an extended position;

FIGS. 5A-B illustrate example views on a latch system for a bin; and

FIG. 5C illustrates an example latch bump geometry for a latch system.

### DETAILED DESCRIPTION

Various embodiments will now be described more fully with reference to the accompanying drawings. Like elements on the drawings are labeled by like reference numerals.

Various examples are described in detail below. While specific implementations are described, it should be understood that this is done for illustration purposes only. Other components and configurations may be used without parting from the spirit and scope of the disclosure. Any individual component (such as a lower bin or a sleeve, or a component on a bin or sleeve) can be separately claimed as no specific embodiments are described herein.

Accordingly, while embodiments are capable of various modifications and alternative forms, the embodiments are shown by way of example in the drawings and will be described herein in detail. It should be understood, however, that there is no intent to limit embodiments to the particular forms disclosed. On the contrary, embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

The present disclosure provides a lifter compatible bin. A bin is disclosed which allows for adjustments of the bin to conform with bin space requirements as well as waste truck interface requirements.

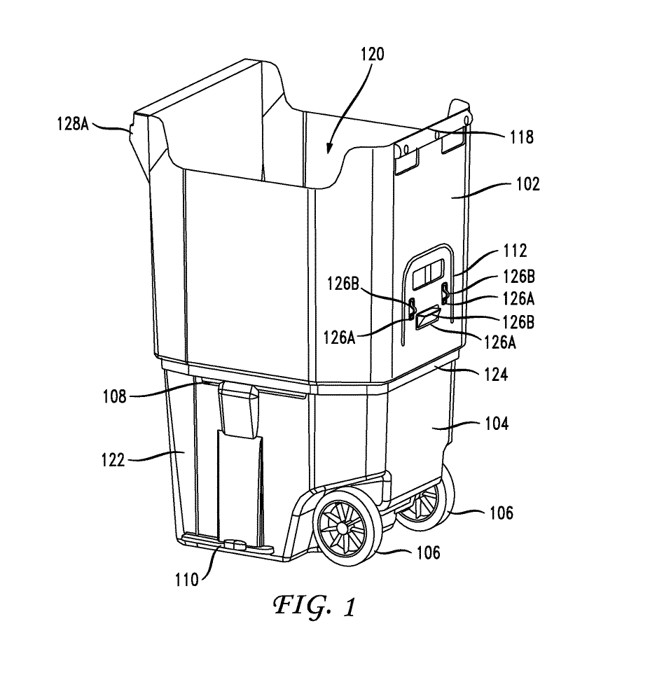

With reference to FIG. 1, an example bin 100 can include a lower bin 104 and a sleeve or upper bin 102 that moves in a telescoping fashion relative to the lower bin. The example bin 100 can include an opening 120 for receiving items, such as waste, for storage in the lower bin 104. Bin 100 can also include wheels 106 for wheeling the bin 100. Bin 100 can include handles 118 for gripping by a user. Handles 118 can be designed with specific attributes for improved grip ergonomics, sleeve rigidity, and center-of-mass balancing. Handles 118 can be weighted to counterbalance the weight of the trash load in the lower bin 104 when the bin 100 is tipped forward. The lower bin 104 and/or the upper bin 102 are shown as having a four sided, rectangular design. The upper and lower bins could have a different shape as well. For example, the design could be circular or cylindrical. The design could be a 3-sided design or a two sided design.

The design disclosed herein also could be more than two pieces. It could encompass three pieces. The three pieces could be a lower bin, a truck interface structure and a handle area. The various components disclosed herein could be configured on two pieces as shown or three or more different pieces as well. Accordingly, all the different pieces may move in a telescopic fashion relative to all their respective lower pieces. Other alternate approaches could include a rotating or a pivoting sleeve.

Disclosed herein is a latch system, which will be further described below, in which there is flexing plastic components that snap back into place. There are also other ways to achieve process of telescoping the upper bin over the lower bin. Some of the components can be used to enable a person to extend the upper bin 102 from the lower bin 104 to the extended position and hold the upper bin 102 in the extended position. For example, pins, clasps, velcro, release mechanisms, and so forth, could be used to enable the upper bin 102 to be extended and held in the extended position until the user desires to collapse the system. The system disclosed provides for a balance of cost, ergonomics and reliability. The various structures and components could be replaced with other structures that provide for the basic features of an adjustable system that in a collapsed mode, fits within a compacting unit and in an extended position has engagement structures positioned in the right place for an automated system to engage with the extended bin to empty the bin.

Bin 100 can include a top catch system 108 for preventing the sleeve 102 from sliding below the top catch system 108 when bin 100 is in an extended mode. The top catch system 108 can include a lip, wall, block, edge, bump, protruding shape, or any other shape which can prevent the sleeve 102 from sliding down when in the extended mode as further described below. Note that while the top catch system 108 is shown as being on a side of the lower bin 104, the top catch system 108 can be positioned in any location of the lower bin 104 for preventing the upper bin or sleeve 102 in the extended position from easily sliding back down over the lower bin 104. There can be one or more structures 108 that perform this function. The one or more top catch systems 108 can be configured in one or more different shapes or sizes around the lower bin 104.

Bin 100 can also include a bottom catch system 110 for preventing the sleeve 102 from sliding off the lower bin 104. The bottom catch system 110 can include a lip, wall, block, edge, bump, protruding shape, or any other shape which can prevent the sleeve 102 from sliding off when in collapsed mode as further described below. Note that while the bottom catch system 110 is shown as being on a particular side of the lower bin 104, the bottom catch system 110 can be positioned in on any side or corner of the lower bin 104 for preventing the sleeve 102 in the extended position from easily sliding back down over the lower bin 104. There can be one or more structures 110 that perform this function. The one or more bottom catch systems 110 can be configured in one or more different shapes or sizes around the lower bin 104.

The top catch system 108 and the bottom catch system 110 can be on a side wall 122 of the lower bin 104. The top catch system 108 and bottom catch system 110 can also be provided on other side walls of the lower bin 104. For example, the top catch system 108 and bottom catch system 110 can be placed on opposite side walls of lower bin 104. The top catch system 108 and the bottom catch system 110 may be positioned on different (e.g., opposite) side walls of the lower bin 104.

Bin 100 can also include a feature 124 to prevent the sleeve 102 from being able to move above the lower bin 104 when in extended mode. Feature 124 can be, for example, a lip, wall, bump, or protruding shape for stopping the sleeve 102 from moving further upward.

Bin 100 can also include a latch system 112. The latch system 112 can include latch features 126A-B for latching the sleeve 102 and the lower bin 104. The latch features 126A-B can include latching objects 126B, such as bumps, on the lower bin 104, which are configured to be inserted or latched on corresponding openings 126A on the sleeve 102.

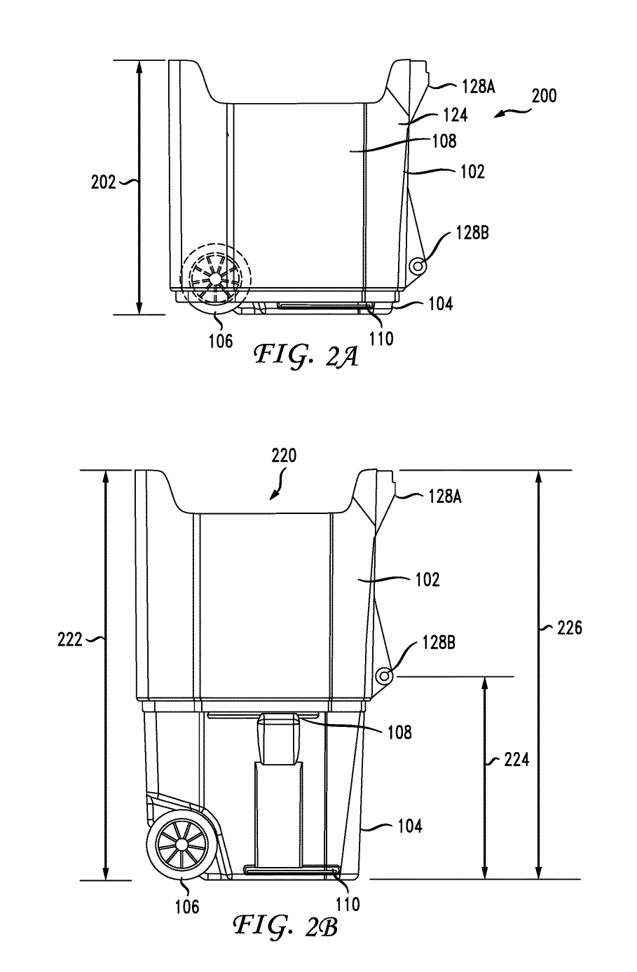

Bin 100 can also include interface feature 128A. Interface feature 128A can provide an interface for coupling with an automated lifter. The interface feature 128A can include lift features for engaging a “comb” style lifter and/or a “bar” style lifter. The interface feature 128A can include an opening for attaching to an interface of the mechanical lifter. The interface feature 128A can also include a bar, as illustrated in FIG. 2B (as either feature 128A or 128B), for engaging a “bar” style lifter. Also shown in FIG. 1 is feature 128A which can provide a structure as part of the upper bin or sleeve for interfacing with an emptying mechanism that can interface with the structure 128A to lift the combined extended bin shown in FIG. 1 to empty its contents.

Alternatively, the sleeve 102 may move in a telescopic fashion relative to the lower bin 104 in a step-like manner so as to be adjustable to different heights for placement into public space compactors of varying sizes and heights as well as interfacing with waste collection vehicles of different sizes and heights.

Accordingly, the top catch system 108 and the bottom catch system 110 (the combined catch system) may be modified to fit within one another (e.g., the top catching system 108 sliding vertically within the bottom catch system 110) and also move in a telescopic fashion with appropriate locking mechanisms that would enable the combined catch system to be fixedly locked at various heights to support the sleeve 102 at corresponding heights and prevent the sleeve 102 from falling over the lower bin 104.

Similarly, the latch system 112 may be modified to provide for one or more latch features (similar to the latch features 126B) at varying heights to be inserted into corresponding opening 126A in order to enable the sleeve 102 to be fixedly locked at different heights relative to the lower bin 104.

In an embodiment, the latching mechanism 112 can be a mechanical knob that is physically coupled to the combined catch system described above (the catch system 108 fitted within the catch system 110), through for example a shaft. Accordingly, by turning the mechanical knob, the catch system 108 can be moved vertically within the catch system 110 causing the combined catch system to expand or shrink, which would in turn cause the sleeve 102 to move vertically relative to the lower bin 102 between the expanded position and the collapsed position, described above. The mechanical knob can also have a lock button associated therewith allowing the knob to be locked and consequently lock the sleeve 102 in one of several positions relative to the lower bin 102, thus enabling and adjustment of the bin 100 at different heights depending on the use thereof, as described above.

In an embodiment, the mechanical knob may be placed on a side of the sleeve 102 that corresponds to a side of the lower bin 104 on which the combined catch system would be located.

FIG. 2A shows bin 100 in a collapsed position 200. Sleeve 102 can be collapsed below top catch system 108 into collapsed position 200. The bottom catch system 110 can prevent sleeve 102 for falling below the bottom catch system 110 when bin 100 is in the collapsed position 200. This can prevent the sleeve 102 from slipping off.

In the collapsed position 200, the bin 100 can be set to a collapsed height 202. The collapsed height 202 can allow bin 100 to adjust to the space and height requirements of a receptacle or compactor.

FIG. 2B shows bin 100 in an extended position 220. In the extended position 220, the sleeve 102 can slide up to the extended height 222. The extended height 222 is greater than the collapsed height 202. Moreover, the extended height 222 can conform to height requirements of automated lifter systems, such as lift interfaces on a waste truck.

The sleeve 102 can be prevented from falling below extended position 220 by top catch system 108. The sleeve 102 can also be prevented from moving above the lower bin 104 by feature 124.

To return to collapsed position 200, the user can pull out latch features 126A-B in the latch system 112, and press on the top of sleeve 102. This can then cause the sleeve 102 and the lower bin 104 to flex to allow the sleeve 102 to move down to the collapsed position 200. For example, the user can pull out the latch openings 126A on the sleeve 102 to disengage the latch objects 126B on the lower bin 104, and press on the sleeve 102 to slide the sleeve 102 down to a collapsed position 200.

Also as shown in FIG. 2B, a telescoping bin can include a lower bin 104 for holding deposited items and an adjustable upper bin 102 coupled with the lower bin. The component can also be separate as well. In other words, claims can be made to just the lower bin, or just the upper bin/sleeve, or to any individual component thereon. The adjustable upper bin 102 is configured to slide down below a first portion of the lower bin 104 to a collapsed position and slide up above a second portion of the lower bin to an extended position. A height of the extended position 226 conforms to a height requirement associated with mechanical processing to remove deposited items in the lower bin via an interfacing component of the adjustable upper bin. In this regard, height 226 is meant to represent an standardized height from the ground to a level of the interfacing component 128A such that a configured mechanism that is to be used to empty the lower bin can engage the interfacing component 128A at an expected height and lift the entire system for emptying the contents. In one aspect, in the extended position, one interfacing component 128A can be at a certain height 226 and a second interfacing component 128B can be at a second height 224. The components 128A and 128B can be rods or any kind of structure that can interface with a mechanical arm or other device for lifting the extended bin and emptying the contents. The interfacing mechanism can include one or both of features 128A and/or 128B or be other configurations as well. To conform to various standards, the height of the top lift interface can be between 825 mm and 851 mm from the ground. The width and depth of the lower and upper bin are not that important. The bin can be structured properly inside a compactor. Standard bins are largely intended for standalone use and thus don't need to interface with any other enclosure.

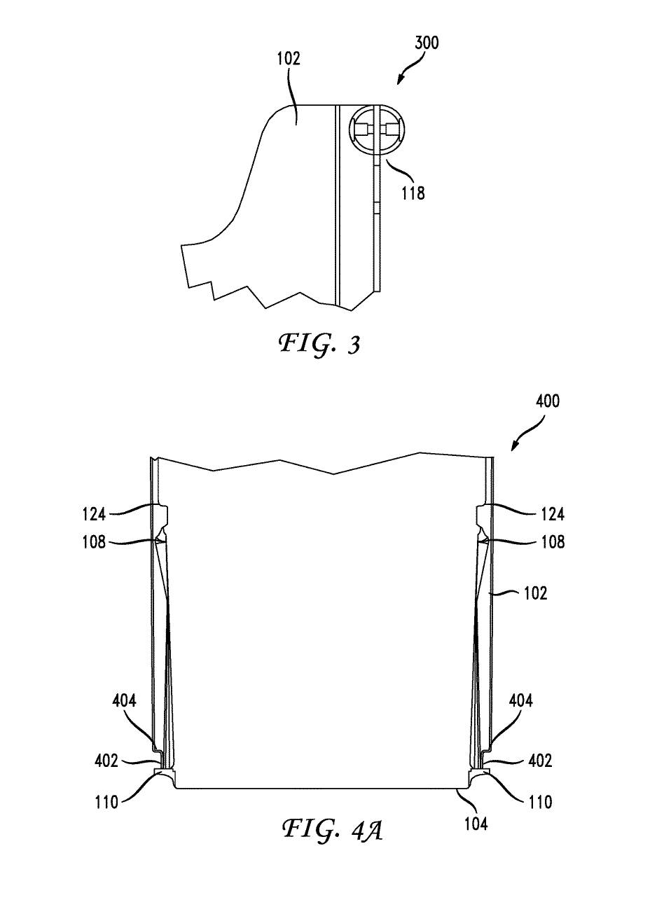

FIG. 3 shows a view 300 of a weighted handle 118 for bin 100. Weighted handle 118 can be placed on a top portion of sleeve 102. The handle 118 can include weight to counterbalance the weight of trash in the bin 100. The handle 118 can include various pounds of weight on top of bin 100 (depending on the size and the weight of the bin 100 and/or the maximum waste size that may be placed therein). When the bin 100 is wheeled or tipped, the weight in the handle 302 can counterbalance the weight of items in the bin 100, which can make the bin 100 easier to maneuver.

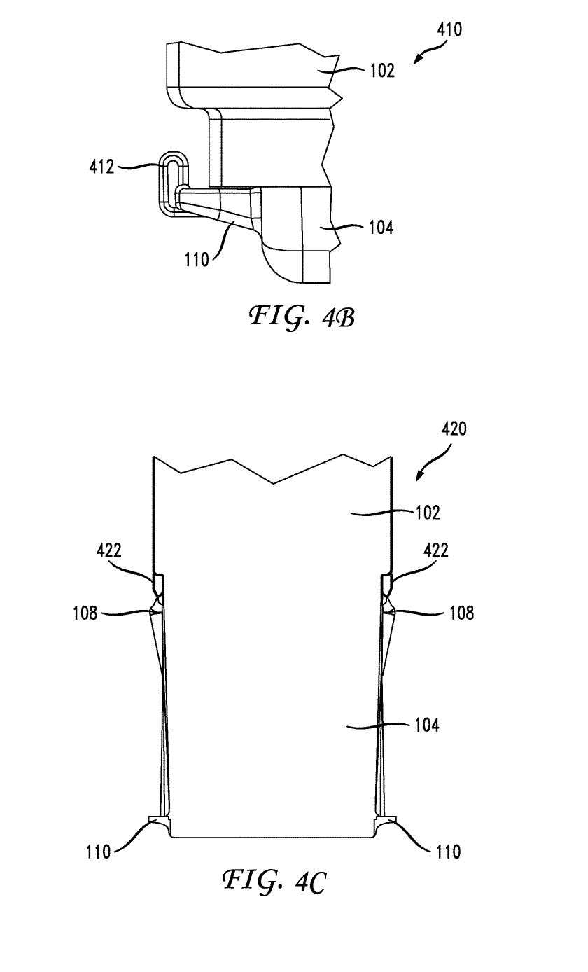

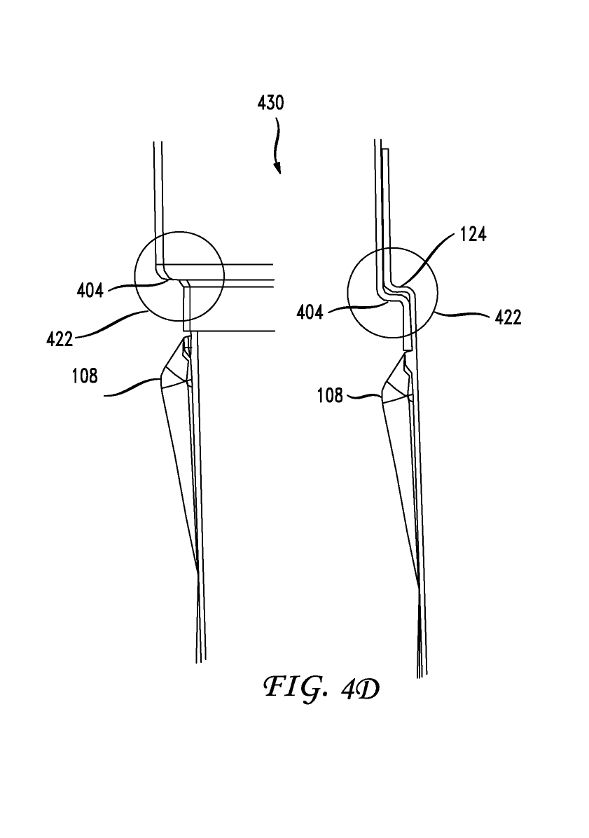

FIG. 4A shows an example view 400 of a bottom catch system 110 on the bin 100. When collapsed, the sleeve 102 can move down over the bottom catch system 110. A bottom portion 402 of the sleeve 102 can be prevented, by the bottom catch system 110, from moving below the bottom catch system 110. Moreover, the bottom portion 402 of the sleeve 102 can also include an interlocking feature 404 which can be configured to latch or interlock with top catch system 108 as further described in FIGS. 4C and 4D, below.

Referring to FIG. 4B, which shows a view 410 of the bottom catch system 110, the bottom catch system 110 can include a return lip 412 for preventing the sleeve 102 from moving below the bottom catch system 110 when in collapsed mode.

Referring to FIG. 4C, which shows extended view 420 of the bin 100, sleeve 102 can be prevented at connection point 422 from moving past the top of the lower bin 104. Referring to FIG. 4D, the connection point 422 can be where the feature 124 on the lower bin 104 couples or interlocks with the interlocking feature 404 at the bottom portion 402 of the sleeve 102. The connection 422 allows the feature 124 and the interlocking feature 404 to couple, interlock, or latch in order to prevent the sleeve 102 from moving above the feature 124. This can prevent sleeve 102 from extending above the lower bin 104 or coming apart from the lower bin 104.

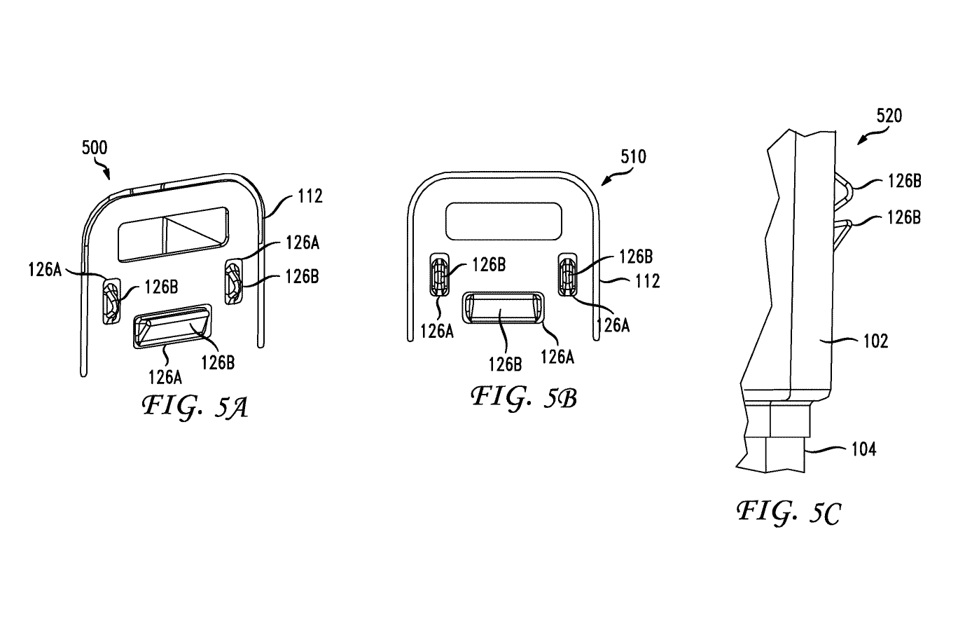

FIG. 5A shows a view 500 of the latch system 112. As shown, the latch system 112 can include the latch openings 126A and the latch objects 126B. The latch openings 126A can be configured to receive the latch objects 126B for latching the sleeve 102 and the lower bin 104. The latch openings 126A can be configured on the sleeve 102 and the latch objects 126B can be configured on the lower bin 104. Thus, when the sleeve 102 is moved up into the extended position 220, the latch objects 126B on the lower bin 104 will go into the latch openings 126A on the sleeve 102 to latch or lock the sleeve 102 and the lower bin 104 in the extended position 220.

FIG. 5B shows a front view 510 of the latch system 112. Front view 510 shows latch objects 126B in an inserted position on latch openings 126A for locking the sleeve 102 in the extended position 220.

FIG. 5C shows a latch object geometry 520 of the latch objects 126B. Latch objects 126B can protrude through latch openings 126A to latch the sleeve 102 in the extended position 200. The shape or geometry of the latch objects 126B can face down, up, and/or out in various ways. Moreover, the size of the latch objects 126B can depend on the size of the latch openings 126A, as well as other factors, such as size of the sleeve 102, the flexibility of the sleeve 102 and/or the lower bin 104, etc.

The various examples described above are provided by way of illustration only and should not be construed to limit the scope of the disclosure. Various modifications and changes may be made to the principles described herein without following the examples and applications illustrated and described herein, and without departing from the spirit and scope of the disclosure. Every individual component of the system described herein can be mixed and matched with any other individual component. Each concept is described as an example component without any specific example being contemplated. For example, one element of the lower bin can be combined with one of the lifter interface components of the upper bin or sleeve. One example might even be simply the upper bin or sleeve independent of the lower bin. Thus, it is contemplated that any individual component described herein could be separately claimed. Claim language reciting “at least one of” a set indicates that one member of the set or multiple members of the set satisfy the claim.

We claim:

1. A bin comprising:
a lower bin for holding deposited items;
a sleeve comprising an adjustable upper bin coupled with the lower bin, wherein the sleeve is configured to slide down below a first portion of the lower bin to a collapsed position and slide up above a second portion of the lower bin to an extended position, wherein the bin has a first height when the sleeve is in the collapsed position and a second height when the sleeve is in the extended position, wherein the second height is greater than the first height, and wherein the first height conforms to a first height requirement of a receptacle for containing the bin and the second height conforms to a second height requirement of an interface associated with a mechanical device for mechanically lifting the bin to remove the deposited items; and
a lifter interface on the sleeve, wherein the lifter interface is located at a position on the sleeve such that the lifter interface couples with the interface associated with the mechanical device at a height specified by the second height requirement when the sleeve is in the extended position and the bin has the second height.

2. The bin of claim 1, further comprising a bottom catch system located on the lower bin for preventing the sleeve from sliding down below the bottom catch system on the lower bin when in the collapsed position, wherein the bottom catch system is located at a bottom portion of the lower bin.

3. The bin of claim 1, further comprising a top catch system located on the lower bin for preventing the sleeve to slide down below the top catch system on the lower bin when in the extended position, wherein the top catch system is located at a top portion of the lower bin.

4. The bin of claim 3, further comprising an upper restraint system located on the lower bin for preventing the sleeve to slide up above the upper restraint system on the lower bin when in the extended position, wherein the upper restraint system is located above the top catch system.

5. The bin of claim 1, further comprising weighted handles configured to counterbalance a weight associated with the bin.

6. A bin comprising:
a first portion configured to hold at least one item therein;
an adjustable second portion configured to couple with the first portion and slide relative to the first portion between a collapsed position and an expanded position, the collapsed position providing a minimum combined height for the first portion and the adjustable second portion in which the adjustable second portion encapsulates the first portion in order for the bin to be placed inside a receptacle, the expanded position providing a maximum combined height for the first portion and the adjustable second portion in order for the bin to interface with a mechanical device for disposing the at least one item; and
one or more holding mechanisms for securing the bin in at least one of the collapsed and expanded positions.

7. The bin of claim 6, wherein the one or more holding mechanisms comprise:
a first holding mechanism configured to prevent the adjustable second portion from sliding below the first portion in the collapsed position,
a second holding mechanism configured to prevent the adjustable second portion from sliding below a top of the second holding mechanism in the expanded position, and
a third holding mechanism configured to prevent the adjustable second portion from moving above and separating from the first portion in the expanded position.

8. The bin of claim 7, wherein
the first holding mechanism is configured to couple with the second holding mechanism at an upper end of the first holding mechanism and a lower end of the second holding mechanism, and
the second holding mechanism is configured to couple with the third holding mechanism at an upper end of the second holding mechanism and a lower end of the third holding mechanism.

9. The bin of claim 6, wherein the adjustable second portion is configured to couple with the first portion via a latching mechanism.

10. The bin of claim 9, wherein the latching mechanism includes one or more latching objects and a corresponding number of openings for coupling the adjustable second portion to the first portion.

11. The bin of claim 10, wherein
the one or more latching objects are located on an outer surface of the first portion, and
the corresponding number of openings are located on an outer surface of the adjustable second portion, each of the corresponding number of openings being configured to receive one of the one or more latching objects.

12. The bin of claim 11, wherein the one or more latching objects are bumps configured to protrude from one of the corresponding number of openings when inserted therein.

13. The bin of claim 6, further comprising an interface located at an upper edge of the adjustable second portion, the interface configured to engage a lifter of the mechanical device for lifting the bin and emptying the at least one item in the expanded position.

14. The bin of claim 13, wherein the interface is configured to engage a comb style lifter.

15. The bin of claim 13, wherein the interface is configured to engage a bar style lifter.

16. The bin of claim 6, further comprising a handle configured to facilitate a movement of the bin, the handle being weighted to counterbalance a weight of the bin in a tilted position.

17. A bin comprising:
a first portion configured to hold at least one item therein;
an adjustable second portion configured to,
encompass the first portion,
move vertically relative to the first portion between a collapsed position and an expanded position, the bin having a higher combined vertical length in the expanded position relative to the collapsed position, and
be fixedly positioned relative to the first portion in at least one intermediary position between the collapsed position and the expanded position; and
a holding mechanism for securing the bin in at least one of the collapsed position, the at least one intermediary position and the expanded positions.

18. The bin of claim 17, wherein the adjustable second portion is fixed at one of the collapsed position, the at least one intermediary position or the expanded position for placement inside a receptacle or interfacing with a mechanical collection device.

19. The bin of claim 17, wherein the holding mechanism comprises:
a first portion configured to slide within a second portion between a first position, a second position and at least one middle position, each of the first position, the second position and the at least one middle position corresponding to the collapsed position, the expanded position and the at least one intermediary position, respectively, the first portion configured to prevent the adjustable second portion from sliding below the first portion in the collapsed position, the second portion configured to prevent the adjustable second portion from sliding below a top of the holding mechanism in the expanded position; and
a third portion configured to prevent the adjustable second portion from moving above and separating from the first portion in the expanded position.

20. The bin of claim 19, further comprising a mechanical knob configured to be physically coupled to the holding mechanism and adjust a sliding of the first portion of the holding mechanism inside the second portion of the holding mechanism to fixedly position the adjustable second portion in one of the expanded position, the collapsed position and one of the at least one intermediary position.
